(19) United States
(12) Patent Application Publication
(10) Pub. No.: US 2016/0178398 A1
(43) Pub. Date: Jun. 23, 2016

(54) Device for Supplying a Hand-Held Power Tool with Energy

(71) Applicant: ROBERT BOSCH GMBH, Stuttgart (DE)

(72) Inventors: Reiner Krapf, Filderstadt (DE); Heiko Sgarz, Leonberg (DE); Ulrich Schuster, Berlin (DE)

(21) Appl. No.: 14/908,845

(22) PCT Filed: Jun. 13, 2014
(86) PCT No.: PCT/EP2014/062309

§ 371 Date: Jan. 29, 2016

(30) Foreign Application Priority Data
Jul. 31, 2013 (DE) 10 2013 214 971.9

(51) Int. Cl. G01D 5/20; H01M 2/10; G01S 13/88; H01M 10/42; G01J 5/10; B25F 5/00; H01M 10/48

(52) U.S. Cl. CPC G01D 5/20; B25F 5/00; H01M 2/1022; H01M 10/48; H01M 10/425; G01J 5/10; G01S 13/88; H01M 2220/30

(57) ABSTRACT

A hand-held power-tool energy supply device configured to supply energy to a hand-held power tool includes at least one locating unit. The locating unit is configured to at least one of locate objects in a workpiece and sense an object temperature of an object disposed in a workpiece. The hand-held power tool includes at least one hand-held power tool interface for removable disposition on the hand-held power tool.

### PRIOR ART

There are already known hand-held power-tool energy supply devices, for supplying energy to hand-held power tools, which have a hand-held power-tool interface for removable disposition on a hand-held power tool.

### DISCLOSURE OF THE INVENTION

The invention is based on a hand-held power-tool energy supply device, in particular a hand-held power tool battery device, for supplying energy to a hand-held power tool, having at least one hand-held power-tool interface for removable disposition on a hand-held power tool.

It is proposed that the hand-held power-tool energy supply device have at least one locating unit for locating objects in a workpiece and/or for sensing an object temperature of an object disposed in a workpiece. Particularly preferably, the hand-held power-tool energy supply device comprises an energy transmission interface for supplying energy to the hand-held power tool. In this case, preferably, a voltage and/or a current that are/is of sufficient magnitude to operate the hand-held power tool can be transmitted by means of the energy transmission interface. “Provided” is to be understood to mean, in particular, specially programmed, designed and/or equipped. That an object is provided for a particular function, is to be understood to mean, in particular, that the object fulfils and/or executes this particular function in at least one application state and/or operating state. Preferably, the hand-held power-tool energy supply device is provided, at least, to supply energy, in particular to supply electrical energy, to a drive unit for the purpose of starting up and during operation.

Preferably, the hand-held power-tool interface is realized as a separable positive and/or non-positive connection interface. “Separable” in this context is to be understood to mean, in particular, non-destructively separable. The hand-held power-tool energy supply device can thus preferably be disposed in a removable manner on an energy-supply receiving interface of a power-tool housing of the hand-held power tool by means of the hand-held power-tool interface. Preferably in this case, a housing unit of the hand-held power-tool energy supply device, together with the locating unit, can be disposed on an energy-supply receiving interface of a power-tool housing of the hand-held power tool by means of the hand-held power-tool interface. The hand-held power-tool interface is preferably disposed on the housing unit of the hand-held power-tool energy supply device. The housing unit, together with the locating unit, can thus preferably be disposed in a removable manner on the hand-held power tool by means of the hand-held power-tool interface. The hand-held power-tool energy supply device thus preferably comprises at least one housing unit, which comprises at least the hand-held power-tool interface for disposing the housing unit in a removable manner on a hand-held power tool.

The locating unit preferably comprises at least one locating element for locating objects such as, for example, electric lines, metallic elements, ferromagnetic elements, fluid lines, etc. For this purpose, the locating element may be realized as an inductive sensor, as a capacitive sensor, as a 50 Hz sensor, as a radar sensor, as an X-ray sensor, as an NMR sensor (Nuclear Magnetic Resonance Sensor), as a terahertz sensor, as an infrared sensor, as a sonic (an ultrasonic) sensor, etc. It is also conceivable, however, for the locating unit to have a number of locating elements other than one locating element. It is conceivable in this case for the locating unit to have a multiplicity of sensors of the same type, in order to achieve an advantageous directional acuity of the locating unit, or for the locating unit to have differing sensors, to make it possible to detect differing types of objects and/or object temperatures of objects in a workpiece by means of the locating unit. Preferably, the locating unit comprises at least one inductive sensor and, in addition, at least one AC sensor. It is thus possible, advantageously, to locate both metal objects and live electric lines in a workpiece such as, for example a wall, etc., by means of the locating unit. In an alternative design of the locating unit, the locating unit preferably comprises at least one radar sensor, additionally at least one AC sensor, and additionally at least one inductive sensor. This makes it possible, advantageously, in addition to determining a location of objects in the workpiece, to determine also the material/material property of the objects (live/non-live, containing metal/not containing metal, ferromagnetic/non-ferromagnetic). Moreover, it is conceivable, alternatively or additionally, for the locating unit to comprise at least one infrared sensor. This makes it possible, advantageously, to determine a temperature of the object and/or to sense a position of the object in the workpiece, such as, for example, a position of a heating pipe, etc. It is also conceivable, however, for the locating unit to comprise a temperature sensor, considered appropriate by persons skilled in the art, for sensing a temperature of an object. In a further alternative design of the locating unit, the locating unit preferably comprises a multiplicity of locating elements of the same type. This enables differing objects in the workpiece to be located separately from each other in an advantageously simple manner or, advantageously, enables a course of an object in the workpiece to be determined. Particularly preferably, for this purpose the locating unit comprises at least one sensor matrix of the locating elements. By this means, advantageously, it is possible for at least one influencing variable of conductive and/or metal-containing elements of the hand-held power-tool energy supply device to be compensated.

The locating unit additionally comprises at least one calibration function for calibrating the locating unit, at least after being disposed on the hand-held power tool. Particularly preferably, the locating unit, in particular at least one locating element of the locating unit, is calibrated automatically after being disposed on the hand-held power tool. Also conceivable is a calibration that can be started manually, by means of the calibration function, as a result of an input by an operator. An automatic calibration, controlled via a workpiece contact sensor, is likewise conceivable.

Preferably, the locating unit is fixedly connected to the housing unit of the hand-held power-tool energy supply device. The locating unit in this case is preferably connected to the housing unit of the hand-held power-tool energy supply device by means of a positive connection, by means of a non-positive connection ad/or by means of a materially bonded connection. It is conceivable in this case for the locating unit to comprise a locating housing, which is fixedly connected to the housing unit of the hand-held power-tool energy supply device. It is likewise conceivable for the locating housing of the locating unit to be designed such that it is integral with the housing unit of the hand-held power-tool energy supply device. “Integral with” is to be understood to mean, in particular, connected at least in a materially bonded manner, for example by a welding process, an adhesive process, an injection process and/or another process considered appropriate by persons skilled in the art, and/or, advantageously, formed in one piece such as, for example, by being produced from a casting and/or by being produced in a single or multi-component injection process and, advantageously, from a single blank. The locating unit is preferably disposed on or in the housing unit of the hand-held power-tool energy supply device, on a side of the housing unit of the hand-held power-tool energy supply device that faces away from the hand-held power-tool interface. The design of the hand-held power-tool energy supply device according to the invention makes it possible, advantageously, to achieve a high degree of protection against unintentional machining of objects present in a workpiece, the locating unit being disposed, advantageously, in a captive manner on the housing unit of the hand-held power-tool energy supply device. Moreover, advantageously, a high degree of application variability can be achieved, since the hand-held power-tool energy supply device can be disposed, with the locating unit, on differing hand-held power tools. In addition, advantageously, retrofitting of hand-held power tools manufactured without a locating function becomes possible.

In an alternative design of the hand-held power-tool energy supply device according to the invention, it is proposed that the hand-held power-tool energy supply device comprise at least one locating-unit receiving interface for receiving a locating unit, in particular a locating unit realized such that it is separate from the hand-held power-tool energy supply device, at least when in a state of having been disposed on the hand-held power tool. The locating unit, in particular the locating unit realized such that it is separate from the hand-held power-tool energy supply device, in this case preferably comprises at least one locating housing, which has at least one coupling interface corresponding to the locating-unit receiving interface. The locating-unit receiving interface is preferably on the housing unit of the hand-held power-tool energy supply device on a side of the housing unit of the hand-held power-tool energy supply device that faces away from the hand-held power-tool interface. The locating unit, in particular the locating unit realized such that it is separate from the hand-held power-tool energy supply device, can thus preferably be disposed in a removable manner on the housing unit, in particular in a removable manner on the locating-unit receiving interface, of the hand-held power-tool energy supply device. The locating-unit receiving interface is preferably realized as a positively and/or non-positively acting connection interface, such as, for example, as a latching-element interface, as a bayonet-closure interface, as a hook-and-loop closure interface, as a plug-in connection interface, etc. Preferably, the locating unit, in particular the locating unit realized such that it is separate from the hand-held power-tool energy supply device, comprises at least one energy supply unit and/or energy storage unit, provided to supply energy to the locating unit, in particular the locating unit realized such that it is separate from the hand-held power-tool energy supply device, when in a state of having been removed from the hand-held power-tool energy supply device. It is conceivable in this case for the energy supply unit and/or energy storage unit of the locating unit, in particular of the locating unit realized such that it is separate from the hand-held power-tool energy supply device, to be supplied with energy from an energy storage unit of the hand-held power-tool energy supply device when in a state of having been disposed on the hand-held power-tool energy supply device, for example in order to charge the energy supply unit and/or energy storage unit of the locating unit, in particular of the locating unit realized such that it is separate from the hand-held power-tool energy supply device. The design of the hand-held power-tool energy supply device according to the invention makes it possible, advantageously, to achieve a high degree of application variability, since the hand-held power-tool energy supply device can be disposed, with the locating unit, on differing hand-held power tools. In addition, advantageously, retrofitting of hand-held power tools manufactured without a locating function becomes possible. Furthermore, advantageously, it becomes possible to operate the locating unit, in particular the locating unit realized such that it is separate from the hand-held power-tool energy supply device, independently from the hand-held power-tool energy supply device. Thus, advantageously, the locating unit, in particular the locating unit realized such that it is separate from the hand-held power-tool energy supply device, can be removed from the hand-held power-tool energy supply device, for example to enable objects to be located in a workpiece in places that are difficult to access.

Furthermore, it is proposed that the hand-held power-tool energy supply device comprise at least one output unit for outputting a signal in dependence on a locating characteristic sensed by means of the locating unit. The output unit may be realized as an acoustic, optical and/or haptic output unit. The locating characteristic is preferably realized as a position characteristic and/or as a temperature characteristic of an object in a workpiece. A signal is thus preferably output, by means of the output unit, in dependence on a sensed position of an object in the workpiece. The signal in this case may be an illumination of a light source (LED, LCD, incandescent bulb, halogen bulb, etc.), a graphical display (LCD, projection onto a workpiece, etc.), a vibration and/or another signal considered appropriate by persons skilled in the art. It is conceivable in this case that the hand-held power-tool energy supply device comprises, in addition to the output unit, a marking unit provided to mark a position of the object, located in the workpiece, on a surface of the workpiece, such as, for example, by means of a light marking, by means of a color marking (stamp, pen, ink, spray paint, etc.), in particular by means of a removable color marking, etc. Moreover, the output unit is preferably provided, in addition to outputting a signal in dependence on a locating characteristic of the locating unit, to output an energy storage characteristic of the energy storage unit of the hand-held power-tool energy supply device, such as, for example, an energy storage characteristic realized as a charge state indication, an energy storage characteristic realized as a possible operating time. The hand-held power-tool energy supply device preferably has at least one evaluation unit for evaluating at least one locating characteristic sensed by means of the locating unit. In addition, the evaluation unit is preferably provided to control the output unit, in order to output a signal in dependence on a locating characteristic of the locating unit. The output unit and the evaluation unit are thus preferably connected to each other for the purpose of transmitting data. Preferably, for example, sensor amplitudes, sensor phases, parameters from an object identification algorithm, etc. are evaluated by means of the evaluation unit. The evaluated data can then be output, for example by means of a bar graph display, by means of a signal strength display, by means of a position indicator, and an object course, an object type, an object depth, an object dimension, an object material, an object temperature, etc., can be described or determined. The design according to the invention makes it possible, advantageously, to achieve a high degree of operating convenience, since an item of information concerning a located object can be communicated to an operator in an advantageously simple manner. Moreover, advantageously, items of information regarding a type, position, etc. of an object, that enable the operator, advantageously, to perform effective machining of a workpiece without, insofar as possible, any unintentional machining of an object in the workpiece, can be displayed to an operator. Advantageously, therefore, consequential damage that may occur, for example, in the case of unintentional machining of an object present in the workpiece (water line, electric line, etc.) can be prevented, at least to a very large extent.

It is additionally proposed that the hand-held power-tool energy supply device comprise at least one energy storage unit, which is provided, at least, to supply energy to the locating unit, at least in one state. Preferably, the energy storage unit is additionally provided to supply energy to the hand-held power tool, in particular when the housing unit of the hand-held power-tool energy supply device has been disposed on the hand-held power tool. Preferably, the energy storage unit is realized as a battery unit. The energy storage unit in this case is preferably provided to supply energy to the locating unit, at least during an operating state, for the purpose of identifying objects in a workpiece. In the alternative design of the hand-held power-tool energy supply device, the energy storage unit is provided, in particular, to supply energy to the locating unit, in particular the locating unit realized so as to be separate from the hand-held power-tool energy supply device, in a on the housing unit of the hand-held power-tool energy supply device by means of the locating-unit receiving interface. It is also conceivable, however, for the locating unit, in particular the locating unit realized so as to be separate from the hand-held power-tool energy supply device, to comprise its own energy supply unit and/or energy storage unit, such as, for example, at least one secondary cell, at least one primary cell, at least one capacitor, etc. It is additionally conceivable for the locating unit, in particular the locating unit realized so as to be separate from the hand-held power-tool energy supply device, to comprise a start-up element, or to be automatically in an activated state for a prescribed period of time after connection to the hand-held power tool and/or to the hand-held power-tool energy supply device, in particular as soon as the hand-held power tool is put into operation and/or energy is drawn from the hand-held power-tool energy supply device. It is additionally conceivable for the locating unit to have a function for automatic identification of workpieces to be machined, such as, for example, building parts. By means of the identification function, locating by the locating unit could be effected automatically after being placed on a workpiece. For this purpose, the locating unit preferably comprises at least one radar sensor, or other workpiece contact identification elements, considered appropriate by persons skilled in the art, such as, for example, an optical sensor, a light barrier, a capacitive sensor, a contact switch, etc. Also conceivable here is a tilt sensor, an acceleration or compass sensor, which are provided to automatically identify tilting of the hand-held power tool and/or of the hand-held power-tool energy supply device. Preferably, energy is supplied automatically to the locating unit, by means of the energy supply unit, as a result of contact identification or tilt identification. The design according to the invention ensures, advantageously, that energy is supplied to the locating unit. Moreover, advantageously, cost savings can be made, since it is possible to dispense with an additional energy source for supplying the locating unit.

It is additionally proposed that the hand-held power-tool energy supply device have at least one data communication interface for transmitting at least one locating characteristic, sensed by means of the locating unit, to at least one open-loop and/or closed-loop control unit of the hand-held power tool. Preferably, the data communication interface uses a standardized communication protocol for transmitting electronic data. It is conceivable in this case for the data communication interface to be constituted, at least partially, by the energy transmission interface, in particular by at least one contact element of the energy transmission interface. It is also conceivable, however, for the data communication interface to be constituted by a wireless interface such as, for example, a WLAN interface, a Bluetooth interface, an infrared interface, an NFC interface (for example, an RFID interface), or by another wireless interface considered appropriate by persons skilled in the art. An “open-loop and/or closed-loop control unit” is to be understood to mean, in particular, a unit having at least one control electronics. A “control electronics” is to be understood to mean, in particular, a unit having a processor unit and having a storage unit, and having an operating program stored in the storage unit. The external data device in this case may be realized as a smartphone, as a table, as a PC, or as another external data device considered appropriate by persons skilled in the art. The design according to the invention makes it possible, advantageously, to transmit data that can be used for evaluating locating characteristics sensed by means of the locating unit. Moreover, advantageously, additional functions can be rendered possible, such as, for example, a function for automatic mapping of lines, drilled holes, etc., or a leveling function, e.g. of a drill, or a tracking function of hand-held power tools and/or of the hand-held power-tool energy supply device, or a thermal-image map compilation function, for compiling a thermal-image map.

It is furthermore proposed that the hand-held power-tool energy supply device have at least one insulation unit for at least partially shielding the locating unit against thermal disturbance variables. Preferably, the insulation unit is provided, at least, to shield at least one locating element, at least partially, against thermal disturbance variables. The insulation unit in this case is preferably provided to shield the at least one locating element, at least partially, against thermal, metallic and/or voltage disturbance variables that have their origin in the hand-held power-tool energy supply device. The insulation unit thus comprises at least one insulation element, which thermally decouples the locating unit and, in particular, the energy storage unit from each other, at least substantially. It is also conceivable, however, for the hand-held power-tool energy supply device to comprise at least one further insulation unit, which shields the locating unit, at least partially, against other disturbance variables. It is proposed, preferably, that the hand-held power-tool energy supply device comprise a temperature sensor, in particular a temperature sensor that is integrated in the housing unit and that is provided to transmit at least one temperature characteristic to the locating unit. This makes it possible, if necessary, to initiate a compensation measure such as, for example, a recalibration or correction of the current locating value, on the basis of values in a stored digital table. The temperature sensor in this case may be connected, by a wired connection or wirelessly, to the locating unit, in particular to the locating unit realized so as to be separate from the hand-held power-tool energy supply device. For this purpose, the hand-held power-tool energy supply device comprises at least one interface to enable data transmission between the locating unit, in particular the locating unit realized so as to be separate from the hand-held power-tool energy supply device, and the temperature sensor for transmitting current temperatures. The design of the hand-held power-tool energy supply device according to the invention makes it possible, advantageously, to ensure reliable operation of the locating unit. Advantageously, overheating of the locating unit can be counteracted, resulting in a long service life.

It is additionally proposed that the hand-held power-tool energy supply device comprise at least the housing unit in which the locating unit is at least partially disposed. The locating unit in this case is disposed inside the housing unit, in particular by more than 30%, preferably by more than 50%, and particularly preferably by more than 60% of a total volume of the housing unit. Advantageously, a compact disposition of the locating unit can be achieved. Moreover, advantageously, the locating unit can be protected against damage, environmental influences, dust, etc.

The invention is additionally based on a locating unit of the hand-held power-tool energy supply device according to the invention. This makes it possible, advantageously, to provide an inexpensive retrofitting solution, in particular in the case of the alternative design of the hand-held power-tool energy supply device having at least the locating-unit receiving interface for receiving the locating unit, at least when in a state of having been disposed on the hand-held power tool.

Furthermore, the invention is based on a hand-held power-tool system, comprising at least one hand-held power tool and comprising at least one hand-held power-tool energy supply device according to the invention. A “hand-held power tool” is to be understood here to mean, in particular, a power tool for performing work on workpieces, that can be transported by an operator without the use of a transport machine. The hand-held power tool has, in particular, a mass of less than 40 kg, preferably less than 10 kg, and particularly preferably less than 5 kg. The hand-held power tool in this case may be realized as a hammer drill and/or chipping hammer, as a percussion drill, as a power drill, as a compass saw, as a circular saw, as a miter saw, etc. The hand-held power-tool system according to the invention makes it possible, advantageously, to effect machining of workpieces in which, advantageously, unintentional machining of objects present in the workpiece can be avoided.

It is additionally proposed that the hand-held power tool have at least one open-loop and/or closed-loop control unit, which is provided to set at least one operating function parameter of the hand-held power tool in dependence on at least one locating characteristic sensed by means of the locating unit. It is conceivable in this case that, by means of a communication of the locating unit and the hand-held power tool, items of information concerning a workpiece material can be provided, by means of which at least one operating function parameter such as, for example, a rotational speed, a vibration damping or a percussion energy can be set automatically by the open-loop and/or closed loop control unit. It is additionally conceivable that, by means of a communication of the locating unit and the hand-held power tool, items of information concerning a depth of a located object can be provided, which can be used by the open-loop and/or closed loop control unit to set and/or limit a maximum drilling depth. For this purpose, the hand-held power tool preferably comprises at least one drilling-depth sensor. It is additionally conceivable that at least one protective measure such as, for example, automatic switch-off, automatic locking, etc. can be initiated by the open-loop and/or closed loop control unit as a result of a communication of the locating unit and the hand-held power tool if, for example, it is identified by means of the locating unit that the hand-held power tool falls the ground. Furthermore, it is conceivable that a contactless control such as, for example, a gesture control, of the hand-held power tool can be realized by the open-loop and/or closed loop control unit, by means of a communication of the locating unit and the hand-held power tool, in particular if the locating unit is designed with at least one radar sensor. Thus, advantageously, a high degree of operating convenience can be achieved by means of the design according to the invention.

The hand-held power-tool energy supply device according to the invention, the locating unit according to the invention and/or the hand-held power-tool system according to the invention are/is not intended in this case to be limited to the application/s and embodiment/s described above. In particular, the hand-held power-tool energy supply device according to the invention, the locating unit according to the invention and/or the hand-held power-tool system according to the invention may have individual elements, components and units that differ in number from a number stated herein, in order to fulfill a principle of function described herein.

### DRAWING

Further advantages are disclosed by the following description of the drawing. The drawing shows exemplary embodiments of the invention. The drawing, the description and the claims contain numerous features in combination. Persons skilled in the art will also expediently consider the features individually and combine them to create appropriate further combinations.

There are shown in:

FIG. 1 a hand-held power-tool system according to the invention, comprising a hand-held power tool according to the invention and having a hand-held power-tool energy supply device according to the invention, in a schematic representation,

FIG. 2 a detail view of a partial section of the hand-held power-tool energy supply device according to the invention, in a state of having been removed from the hand-held power tool according to the invention, in a schematic representation,

FIG. 3 an exemplary disposition of a locating unit of the hand-held power-tool energy supply device according to the invention in a housing unit of the hand-held power-tool energy supply device according to the invention, in a schematic representation,

FIG. 4 a further exemplary disposition of a locating unit of the hand-held power-tool energy supply device according to the invention in a housing unit of the hand-held power-tool energy supply device according to the invention, in a schematic representation,

FIG. 5 a further exemplary disposition of a locating unit of the hand-held power-tool energy supply device according to the invention in a housing unit of the hand-held power-tool energy supply device according to the invention, in a schematic representation,

FIG. 6 a detail view of an alternative hand-held power-tool energy supply device according to the invention, in a schematic representation, and

FIG. 7 an exemplary disposition of a locating unit of the hand-held power-tool energy supply device according to the invention on a housing unit of the alternative hand-held power-tool energy supply device according to the invention, in a schematic representation.

### DESCRIPTION OF THE EXEMPLARY EMBODIMENTS

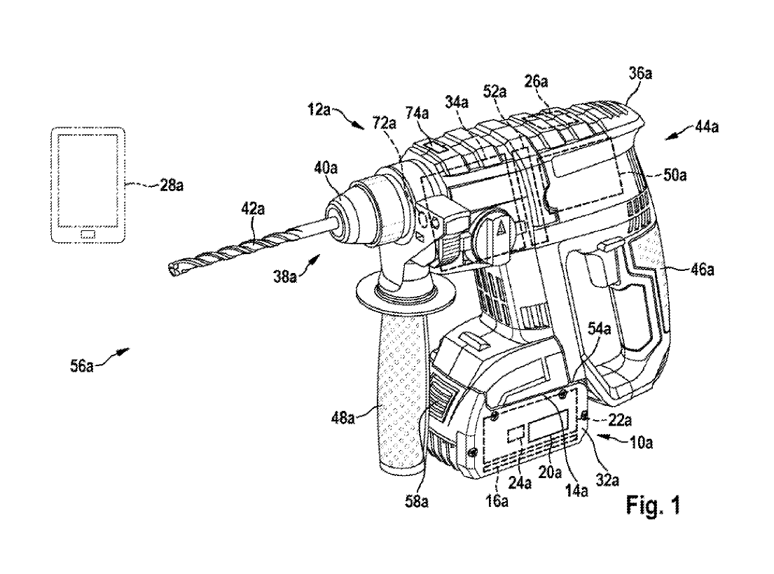

FIG. 1 shows a hand-held power-tool system 56a, which comprises at least a hand-held power tool 12a and at least a hand-held power-tool energy supply device 10a. The hand-held power tool 12a is realized as a hammer drill and/or chipping hammer. It is also conceivable, however, for the hand-held power tool 12a, in an alternative design, not represented here, to be realized as another hand-held power tool, considered appropriate by persons skilled in the art, such as, for example, as a percussion drill, as a power drill, as a compass saw, as a circular saw, as a miter saw, etc. The hand-held power tool 12a represented in FIG. 1 comprises at least one percussion mechanism device 34a for generating a percussive impulse in at least one operating state of the hand-held power tool 12a. The hand-held power tool 12a additionally comprises a power-tool housing 36a, disposed on which, in a front region 38a, there is a tool receiver 40a of the hand-held power tool 12a for receiving an insert tool 42a. On a side 44a that faces away from the front region 38a, the hand-held power tool 12a comprises a main handle 46a for guiding the hand-held power tool 12a and for transmitting a force, in particular a pressing force, from an operator onto the hand-held power tool 12a. The hand-held power tool 12a is additionally realized with a separable ancillary handle 48a. The ancillary handle 48a in this case may be separably fastened to the power-tool housing 36a via a latching connection, or other connections considered appropriate by persons skilled in the art.

For the purpose of generating a drive moment, and for generating a percussive impulse by means of the percussive mechanism device 34a, the hand-held power tool 12a has a drive unit 50a. A drive moment of the drive unit 50a for generating a percussive impulse is transmitted to the percussive mechanism device 34a via an output unit 52a of the hand-held power tool 12a. It is also conceivable, however, for the hand-held power tool 12a to be realized such that it is decoupled from the output unit 52a, and for the drive unit 50a, for the purpose of generating a percussive impulse, to act substantially directly upon the percussive mechanism device 34a. A percussive impulse of the percussive mechanism device 4a is generated in a manner known to persons skilled in the art. In addition, via the output unit 52a, the drive moment is transmitted to the tool receiver 40a, via a rotary entrainment element (not represented in greater detail here) disposed on the tool receiver 40a, for the purpose of generating a rotational motion. The hand-held power tool 12a is thus of a design that is at least substantially already known to persons skilled in the art.

The hand-held power tool 12a is realized as a hand-held power tool that can be operated by battery, and that can be supplied with energy by means of the hand-held power-tool energy supply device 10a. The hand-held power-tool energy supply device 10a is realized as a hand-held power-tool battery device. In this case, the hand-held power-tool energy supply device 10a, for the purpose of being disposed in a removable manner on the hand-held power tool 12a, comprises at least one hand-held power-tool interface 14a. The hand-held power-tool interface 14a is realized as a separable positive and/or non-positive connection interface. Thus, by means of the hand-held power-tool interface 14a, the hand-held power-tool energy supply device 10a can be disposed in a removable manner on an energy-supply receiving interface 54a of the power-tool housing 36a of the hand-held power tool 12a.

The hand-held power-tool interface 14a is disposed on a housing unit 32a of the hand-held power-tool energy supply device 10a. For the purpose of guiding the housing unit 32a while the hand-held power-tool energy supply device 10a is being disposed on the hand-held power tool 12a, the hand-held power-tool interface 14a comprises at least one guide element (not represented in greater detail here) already known to persons skilled in the art. The guide element is provided to guide the housing unit 32a translationally while being disposed on the hand-held power tool 12a. The guide element in this case may be realized as a guide rib, as a guide groove, etc. When the hand-held power-tool energy supply device 10a is being disposed on the hand-held power tool 12a, the guide element acts in combination with a counter-guide element (not represented in greater detail here) of the energy-supply receiving interface 54a, in a manner already known to persons skilled in the art. The counter-guide element is of a design that corresponds to the guide element. In addition, for the purpose of fixing the housing unit 32a to the hand-held power tool 12a, the hand-held power-tool interface 14a comprises at least one fixing element (not represented in greater detail here), which is of a design already known to persons skilled in the art. The fixing element in this case may be realized as an elastic latching element, or other fixing element considered appropriate by persons skilled in the art. For the purpose of fixing the housing unit 32a to the hand-held power tool 12a, the fixing element is provided to act in combination with a counter-fixing element (not represented in greater detail here) of the energy-supply receiving interface 54a that is realized to correspond to the fixing element. For the purpose of actuating the fixing element, and consequently to release a fixing of the housing unit 32a to the hand-held power tool 12a, the hand-held power-tool interface 14a has at least one actuating element 58a. The actuating element 58a is movably mounted on the housing unit 32a. The actuating element 58a in this case is provided to move the fixing element for the purpose of releasing a positive and/or non-positive connection between the fixing element and the counter-fixing element, in a manner already known by persons skilled in the art.

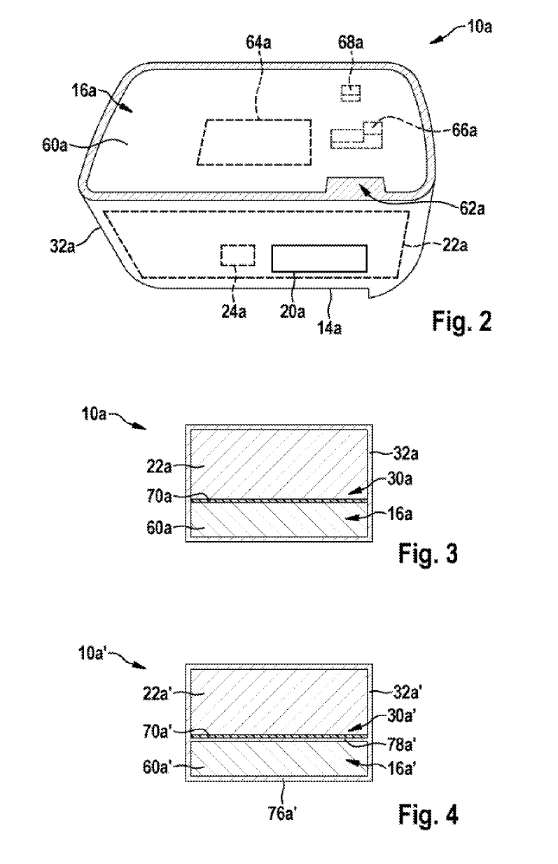

FIG. 2 shows a partial section of the hand-held power-tool energy supply device 10a when in a state of having been removed from the hand-held power tool 12a. The hand-held power-tool energy supply device 10a has at least one locating unit 16a, at least for locating objects in a workpiece and/or for sensing an object temperature of an object disposed in a workpiece. The locating unit 16a is disposed, at least partially, in the housing unit 32a. The locating unit 16a in this case comprises at least one electronics carrier element 60a, which is disposed in the housing unit 32a. The electronics carrier element 60a is realized as a printed circuit board. For the purpose of being disposed in the housing unit 32a, the electronics carrier element 60a has at least one fastening region 62a. The fastening region 62a is provided to fix the electronics carrier element 60a in the housing unit 32a by means of a positive connection and/or by means of a non-positive connection. For this purpose, the hand-held power-tool energy supply device 10a may comprise, for example, at least one latching element, at least one screw, at least one clamp-closure element, etc., which acts in combination with the fastening region 62a and/or with the housing unit 32a for the purpose of fixing the electronics carrier element 60a. The housing unit 32a surrounds the electronics carrier element 60a, when disposed in the housing unit 32a, by more than 60% of a total extent of the electronics carrier element 60a. The electronics carrier element 60a is thus completely surrounded by outer walls of the housing unit 32a (represented schematically in FIG. 3). In this case, the electronics carrier element 60a, and consequently at least a major part of the locating unit 16a, are disposed in the housing unit 32a on a side of the housing unit 32a that faces away from the hand-held power-tool interface 14a.

In an alternative design of the hand-held power-tool energy supply device 10a′, in respect of a disposition of the locating unit 16a′ on the housing unit 32a′, and in particular a disposition of the electronics carrier element 60a′ on the housing unit 32a′ according to FIG. 4, the locating unit 16a′ has a locating housing 76a′, which is realized so as to be at least partially integral with the housing unit 32a′. The locating housing 76a′ in this case has at least one intermediate base element 78a′, which separates the electronics carrier element 60a′ or disposes it at a distance from an energy storage unit 22a′ of the hand-held power-tool energy supply device 10a′. The electronics carrier element 60a in this case is disposed on the intermediate base element 78a′.

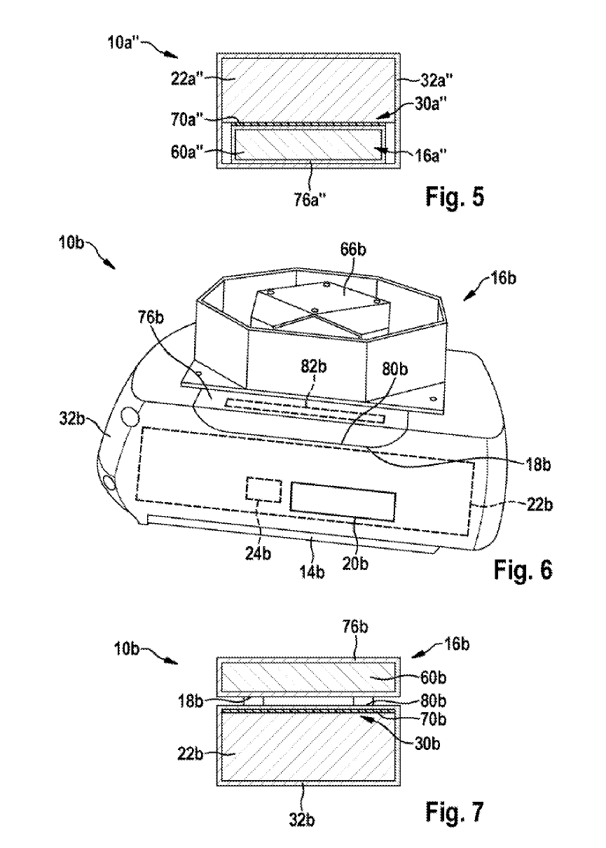

In a further alternative design of the hand-held power-tool energy supply device 10a″, in respect of a disposition of the locating unit 16a″ on the housing unit 32a″, and in particular a disposition of the electronics carrier element 60a″ on the housing unit 32a″ according to FIG. 5, the locating unit 16a″ has a locating housing 76a″, which is realized so as to be separate at least from housing unit 32a″. The locating housing 76a″ is disposed entirely inside the housing unit 32a″. The locating housing 76a″ in this case is provided to hermetically separate off the locating unit 16a″ from an energy storage unit 22a″ of the hand-held power-tool energy supply device 10a″, in order to achieve an advantageously thermal insulation. In this case, the electronic carrier element 60″ is disposed inside the locating housing 76a″.

Further designs of the hand-held power-tool energy supply device 10a, considered appropriate by persons skilled in the art, in respect of a disposition of the locating unit 16a on the housing unit 32a, and in particular a disposition of the electronics carrier element 60a on the housing unit 32a, are likewise conceivable.

The electronics carrier element 60a is provided to accommodate components of the locating unit 16a and to connect them electronically to each other. In this case, at least one locating element 66a of the locating unit 16a is disposed on the electronics carrier element 60a. The locating element 66a is realized as an inductive sensor. The locating unit 16a additionally comprises at least one further locating element 68a, which is disposed on the electronics carrier element 60a. The further locating element 68a is realized as an AC-sensor. It is also conceivable, however, for the locating unit 16a to comprise only one locating element 66a, which is disposed on the electronics carrier element 60a. In addition, it is also conceivable, however, for the locating unit 16a to comprise a number of locating elements 66a, 68a other than two that are disposed on the electronics carrier element 60a, the locating elements 66a, 68a being realized as sensors of differing sensor types or as sensors of the same sensor type.

The hand-held power-tool energy supply device 10a additionally comprises at least one evaluation unit 64a, which is disposed on the electronics carrier element 60a. The evaluation unit 64a is provided to evaluate at least one locating characteristic sensed by means of the locating unit 16a. The evaluation unit 64a in this case is provided to evaluate locating characteristics sensed by means of the locating element 66a and the further locating element 68a. This makes it possible to determine a position and/or an object in a workpiece, in a manner already known to persons skilled in the art.

Furthermore, the hand-held power-tool energy supply device 10a comprises at least one output unit 20a for outputting a signal in dependence on a locating characteristic sensed by means of the locating unit 16a. The output unit 20a is electronically connected to the evaluation unit 64a. In this case, the output unit 20a is controlled by the evaluation unit 64a for the purpose of outputting a signal. The output unit 20a is realized as an optical output unit. The output unit 20a comprises at least one LED for outputting a signal. Moreover, it is conceivable for the output unit 20a to comprise, as an alternative or in addition to the at least one LED, an LC display, by means of which a position of an object in the workpiece can be displayed to an operator. It is also conceivable, however, for the output unit 20a to be provided, alternatively or additionally, as a haptic and/or acoustic output unit 20a, and for the output unit 20a to comprise an output element other than an LED.

Moreover, the output unit 20a is provided to output a signal in dependence on an energy-storage unit characteristic of the energy storage unit 22a, such as, for example, a charge state, etc. It is conceivable in this case that the output unit 20a, in at least one operating state, uses the at least one LED for outputting a signal in dependence on a locating characteristic sensed by means of the locating unit 16a and, in a further operating state, uses the at least one LED for outputting a signal in dependence on an energy-storage unit characteristic. It is also conceivable, however, for the output unit 20a to have a multiplicity of LEDs, at least one LED being provided for outputting a signal in dependence on a locating characteristic sensed by means of the locating unit 16a, and at least one further LED being provided for outputting a signal in dependence on an energy-storage unit characteristic.

The hand-held power-tool energy supply device 10a additionally comprises at least the energy storage unit 22a, which is provided, at least, to supply energy to the locating unit 16a, at least in one state. The energy storage unit 22a is realized as a battery unit. The hand-held power-tool energy supply device 10a additionally has at least one insulation unit 30a for at least partially shielding the locating unit 16a against thermal disturbance variables. The insulation unit 30a in this case is provided to realize a thermal insulation between the energy storage unit 22a and the locating unit 16a. For this purpose, the insulation unit 30a comprises at least one insulation element 70a, which is disposed between the energy storage unit 22a and the locating unit 16a (FIG. 3). The insulation element 70a in this case may be realized, for example, as a structural element having ventilation passages, or it may be realized as another insulation element considered appropriate by persons skilled in the art, such as, for example, as a rigid-foam insulation element, a polystyrene insulation element, a polyurethane insulation element, etc. It is also conceivable for the insulation unit 30a to comprise, alternatively or additionally, at least one cooling element for removing heat, such as, for example, a cooling rib element. It would also be conceivable for the hand-held power-tool energy supply device 10a to be designed with an active cooling and/or ventilation unit such as, for example, a fan unit, a water cooling unit, etc., that can be supplied with energy by means of the energy storage unit 22a.

Furthermore, the hand-held power-tool energy supply device 10a comprises at least one data communication interface 24a for transmitting at least one locating characteristic, sensed by means of the locating unit 16a, to at least one open-loop and/or closed loop control unit 26a of the hand-held power tool 12a and/or to an external data device 28a (represented merely by a broken line in FIG. 1). It is also conceivable, however, for the hand-held power tool 12a to have an additional data communication interface, which is provided to transmit electronic data to the external data device 28a, for example to enable an evaluation, or analysis, to be performed. The open-loop and/or closed loop control unit 26a of the hand-held power tool 12a is provided to set at least one operating function parameter of the hand-held power tool 12a in dependence on at least one locating characteristic sensed by means of the locating unit 16a. It is conceivable in this case that, by means of a communication of the locating unit 16a and the hand-held power tool 12a, items of information concerning a workpiece material can be provided, by means of which at least one operating function parameter such as, for example, a rotational speed, a vibration damping or a percussion energy can be set automatically by the open-loop and/or closed loop control unit 26a.

It is additionally conceivable that, by means of a communication of the locating unit 16a and the hand-held power tool 12a, items of information concerning a depth of a located object can be provided, which can be used by the open-loop and/or closed loop control unit 26a to set and/or limit a maximum drilling depth. For this purpose, the hand-held power tool 12a preferably comprises at least one drilling-depth sensor 72a (FIG. 1). It is additionally conceivable that at least one protective measure such as, for example, automatic switch-off, automatic locking, etc. can be initiated by the open-loop and/or closed loop control unit 26a as a result of a communication of the locating unit 16a and the hand-held power tool 12a if it is identified by means of the locating unit 16a, for example by an acceleration sensor (not represented in greater detail here) of the locating unit 16a that the hand-held power tool falls the ground. Furthermore, it is conceivable that a contactless control such as, for example, a gesture control, of the hand-held power tool 12a can be realized by the open-loop and/or closed loop control unit 26a, by means of a communication of the locating unit 16a and the hand-held power tool 12a, in particular if the locating unit 16a is designed with at least one radar sensor. Moreover, a communication of the locating unit 16a and the external data device 28a makes it possible to realize an evaluation of the locating unit 16a, or to achieve a tracking of the hand-held power-tool energy supply device 10a, or of the hand-held power tool 12a connected to the hand-held power-tool energy supply device 10a. It is thereby possible to achieve a monitoring function, by which a location of the hand-held power-tool energy supply device 10a, or of the hand-held power tool 12a connected to the hand-held power-tool energy supply device 10a, is indicated to an operator. The data communication interface 24a is preferably realized as a wireless data communication interface 24a. It is also conceivable, however, in an alternative design of the invention, for the data communication interface 24a to be realized as a wire-connected data communication interface 24a.

By means of the data communication interface 24a, the locating unit 16a can additionally be connected, via the open-loop and/or closed loop control unit 26a, to a hand-held power-tool output unit 74a of the hand-held power tool 12a. It is thus possible to achieve an output of a signal (optical/acoustic/haptic signal) by means of the hand-held power-tool output unit 74a in dependence on a locating characteristic sensed by means of the locating unit 16a. If there is a data connection between the locating unit 16a and the hand-held power-tool output unit 74a, it is conceivable for output elements of the hand-held power-tool output unit 74a to be provided for outputting a signal in dependence on a locating characteristic sensed by means of the locating unit 16a, while the output unit 20a is switched to a readiness mode.

An alternative exemplary embodiment is represented in FIGS. 6 and 7. Components, features and functions that remain substantially the same are denoted, in principle, by the same references. To distinguish the exemplary embodiment, the letters a and b have been appended to the references of the exemplary embodiments. The description that follows is limited substantially to the differences in comparison with the first exemplary embodiment, described in FIGS. 1 to 5, and reference may be made to the description of the first exemplary embodiment in FIGS. 1 to 5 in respect of components, features and functions that remain the same.

FIGS. 6 and 7 show an alternative hand-held power-tool energy supply device 10b. The hand-held power-tool energy supply device 10b is provided to supply energy to a hand-held power tool 12a according to FIG. 1. In this case, the hand-held power-tool energy supply device 10b comprises at least one hand-held power-tool interface 14b for removable disposition on the hand-held power tool 12a. The hand-held power-tool energy supply device 10b represented in FIGS. 6 and 7 can thus be disposed on the hand-held power tool 12a as an alternative to the hand-held power-tool energy supply device 10b represented in FIGS. 1 to 5.

The hand-held power-tool energy supply device 10b comprises at least one locating-unit receiving interface 18b for receiving a locating unit 16b, at least when in a state of having been disposed on the hand-held power tool 12a. The hand-held power-tool energy supply device 10b and the locating unit 16b thus together constitute a locating and energy supply system. The locating unit 16b in this case preferably comprises at least one locating housing 76b, which has at least one coupling interface 80b that corresponds to the locating-unit receiving interface 18b. The locating-unit receiving interface 18b is disposed on the housing unit 32b, on a side of a housing unit 32b of the hand-held power-tool energy supply device 10b that faces away from the hand-held power-tool interface 14b. The locating unit 16b can thus be disposed in a removable manner on the housing unit 32b of the hand-held power-tool energy supply device 10b. The locating-unit receiving interface 18b is realized as a positively and/or non-positively acting connection interface such as, for example, as a latching-element interface, as a bayonet-closure interface, as a hook-and-loop closure interface, as a plug-in connection interface, etc.

The locating unit 16b additionally comprises at least one energy supply unit and/or energy storage unit 82b, which is provided to supply energy to the locating unit 16b when in a state of having been removed from the hand-held power-tool energy supply device 10b. The energy supply unit and/or energy storage unit 82b, when in a state of having been disposed on the hand-held power-tool energy supply device 10b, can be recharged by means of an energy storage unit 22b of the hand-held power-tool energy supply device 10b. The hand-held power-tool energy supply device 10b thus comprises at least one energy storage unit 22b, which is provided, at least, to supply energy to the locating unit 16b, at least in one state.

Furthermore, the hand-held power-tool energy supply device 10b comprises at lease one output unit 20b for outputting a signal in dependence on a locating characteristic sensed by means of the locating unit 16b. The output unit 20b is electronically connected to the locating unit 16b, after the locating unit 16b has been disposed on the locating-unit receiving interface 18b. This enables a signal to be output as a result of a locating characteristic being sensed by means of a locating element 66b realized as a radar sensor. It is also conceivable, however, for the locating unit 16b to comprise a further output unit (not represented in greater detail here), in order to output a signal in dependence on a locating characteristic sensed by means of the locating unit 16b, when in a state of having been removed from the hand-held power-tool energy supply device 10b.

Furthermore, the hand-held power-tool energy supply device 10b comprises at least one data communication interface 24b for transmitting at least one locating characteristic, sensed by means of the locating unit 16b, to at least one open-loop and/or closed loop control unit 26b of the hand-held power tool 12a and/or to an external data device (not represented in greater detail here). The data communication interface 24b in this case is provided, when in a state of having been disposed on the hand-held power-tool energy supply device 10b, to transmit data electronically to at least one open-loop and/or closed loop control unit 26b of the hand-held power tool 12a and/or to the external data device.

The hand-held power-tool energy supply device 10b additionally comprises at least one insulation unit 30b for at least partially shielding the locating unit 16b against thermal disturbance variables. The insulation unit 30b in this case is disposed in the housing unit 32b of the hand-held power-tool energy supply device 10b. The insulation unit 30b is thus provided to at least partially shield the locating unit 16b, at least when in a state of having been disposed on the hand-held power-tool energy supply device 10b, against thermal disturbance variables. In respect of further functions and features of the hand-held power-tool energy supply device 10b represented in FIGS. 6 and 7, reference may be made to the description of the hand-held power-tool energy supply device 10a represented in FIGS. 1 to 5.

1. A hand-held power-tool energy supply device configured to supply energy to a hand-held power tool, the energy supply device comprising:
at least one locating unit configured to at least one of locate objects in a workpiece and sense an object temperature of an object disposed in a workpiece,
wherein the hand-held power tool includes at least one hand-held power tool interface for removable disposition on the hand-held power tool.

2. The hand-held power-tool energy supply device as claimed in claim 1 further comprising:
at least one locating-unit receiving interface configured to receive a locating unit when disposed on the hand-held power tool.

3. The hand-held power-tool energy supply device as claimed in claim 1 further comprising:
at least one output unit configured to output a signal in dependence on a locating characteristic sensed using the locating unit.

4. The hand-held power-tool energy supply device as claimed in claim 1, further comprising:
at least one energy storage unit configured to supply energy to the locating unit in one state.

5. The hand-held power-tool energy supply device as claimed in claim 1, further comprising:
at least one data communication interface configured to transmit at least one locating characteristic, sensed using the locating unit, to at least one of at least one open-loop and at least one closed-loop control unit of at least one of the hand-held power tool and of an external data device.

6. The hand-held power-tool energy supply device as claimed in claim 1, further comprising:
at least one insulation unit configured to at least partially shield the locating unit against thermal disturbance variables.

7. The hand-held power-tool energy supply device as claimed by claim 1, further comprising:
at least one housing unit, in which the locating unit is at least partially disposed.

8. A locating unit of a hand-held power-tool energy supply device, the locating unit configured to at least one of locate objects in a workpiece and sense an object temperature of an object disposed in a workpiece, wherein the hand-held power-tool energy supply device is configured to supply energy to a hand-held power tool, the hand-held power tool including:
at least one hand-held power tool interface configured to remove disposition on the hand-held power tool.

9. A hand-held power-tool system, comprising:
at least one hand-held power tool; and
at least one hand-held power-tool energy supply device, the hand-held power-tool energy supply device including:
at least one locating unit for at least one of locating objects in a workpiece and sensing an object temperature of an object disposed in a workpiece,
wherein the hand-held power tool includes at least one hand-held power tool interface configured to remove disposition on the hand-held power tool, and
wherein the hand-held power-tool energy supply device is configured to supply energy to the hand-held power tool.

10. The hand-held power-tool system as claimed in claim 9, wherein the hand-held power tool includes:
at least one of at least one open-loop and at least one closed-loop control unit, which is provided to set at least one operating function parameter of the hand-held power tool in dependence on at least one locating characteristic sensed using the locating unit.

11. The hand-held power tool energy supply device of claim 1, wherein the hand-held power tool energy supply device is a hand-held power tool battery device.
